(19) United States
(12) Patent Application Publication
(10) Pub. No.: US 2020/0401683 A1
(43) Pub. Date: Dec. 24, 2020

(54) INFORMATION PROCESSING APPARATUS, INFORMATION PROCESSING METHOD, AND PROGRAM

(71) Applicant: Sony Corporation, Tokyo (JP)

(72) Inventors: Akihiko IZUMI, Kanagawa (JP); Masahiro HARA, Tokyo (JP)

(73) Assignee: Sony Corporation, Tokyo (JP)

(21) Appl. No.: 16/979,177

(22) PCT Filed: Dec. 17, 2018
(86) PCT No.: PCT/JP2018/046347

§ 371 Date: Sep. 9, 2020

(30) Foreign Application Priority Data
Mar. 16, 2018 (JP) 2018-049065

(51) Int. Cl. G06F 21/32; G06F 21/45; H04N 1/44

(52) U.S. Cl. CPC G06F 21/32; H04N 1/4433; G06F 21/45

(57) ABSTRACT

An information processing apparatus according to an embodiment of the present technology includes an acquisition section, a setting section, and a processing execution section. The acquisition section acquires reliability of modal authentication executed on a user. The setting section sets a reliability threshold on the basis of a request requested by the user. The processing execution section suspends execution of processing in response to the request of the user until the reliability of the acquired modal authentication becomes larger than the set reliability threshold.

### TECHNICAL FIELD

The present technology relates to an information processing apparatus that can be applied to authentication of a user, an information processing method, and a program.

### BACKGROUND ART

In the related art, a technique for recognizing a user, such as a face authentication technique, has been widely used. For example, Patent Document 1 discloses a system capable of providing a service with user recognition more flexibly. In the system described in Patent Document 1, first observation information such as a physical characteristic of a user is collated with at least a part of second observation information such as a physical characteristic of the user in the past. This makes it possible to recognize the user and a change of the user (paragraphs [0015] to [0021], FIG. 3, etc. of Patent Document 1).

### CITATION LIST

### Patent Literature

Patent Literature 1: Japanese Patent Application Laid-open No. 2016-225938

### DISCLOSURE OF INVENTION

### Technical Problem

When performing such user authentication, it is important to fully prevent impersonation to the user and to achieve high security. On the other hand, if the user is frequently requested to enter a password to increase security, usability is degraded.

In view of the above circumstances, an object of the present technology is to provide an information processing apparatus capable of improving security while exhibiting high usability, an information processing method, and a program.

### Solution to Problem

In order to achieve the above object, an information processing apparatus according to an embodiment of the present technology includes an acquisition section, a setting section, and a processing execution section.

The acquiring section acquires reliability of modal authentication executed on a user.

The setting section sets a reliability threshold on the basis of a request requested by the user.

The processing execution section suspends the execution of the processing in response to the request of the user until the reliability of the acquired modal authentication becomes larger than the set reliability threshold.

In the information processing apparatus, the execution of the processing in response to the request of the user is suspended until the reliability of the modal authentication becomes larger than the reliability threshold set on the basis of the request of the user. This makes it possible to improve security while achieving high usability.

The setting section may set the reliability threshold on the basis of the type of the request of the user.

This makes it possible to prevent misrecognition of the user and to improve the security.

The processing execution section may execute processing based on an authentication result of the modal authentication if the reliability of the acquired modal authentication becomes larger than the set reliability threshold.

If the authentication result of the modal authentication is valid, the processing execution section may execute processing in response to the request of the user.

The processing execution section may reject the request of the user if the authentication result of the modal authentication is invalid.

This makes it possible to reject requests other than the user and improve security.

The processing execution section may select a warning mode if the authentication result of the modal authentication is invalid.

The warning mode may be a mode in which the execution of the modal authentication on the user is restricted.

The warning mode may be a mode in which the execution of the modal authentication on the user is prohibited.

The setting section may set a timeout time on the basis of the request of the user. In this case, the processing execution section may determine whether or not to continue suspending of the execution of the processing in response to the request of the user on the basis of the timeout time.

The setting section may set the timeout time on the basis of the type of the request of the user.

The processing execution section may restrict the execution of the modal authentication on the user if the timeout time elapses before the reliability of the modal authentication becomes larger than the reliability threshold.

The processing execution section may determine a possibility that the reliability of the modal authentication becomes larger than the reliability threshold before the timeout time elapses.

The processing execution section may restrict the execution of the modal authentication on the user if there is no possibility that the reliability of the modal authentication will be larger than the reliability threshold before the timeout time elapses.

If the reliability of the modal authentication is not likely to become larger than the reliability threshold before the timeout time elapses, the processing execution section may execute intermediate processing for increasing the reliability of the modal authentication.

The processing execution section may execute, as the intermediate processing, processing including requesting the user to take an action for increasing the reliability of the modal authentication.

The processing execution section may select the intermediate processing on the basis of a burden on the user when performing an action required for the user to increase reliability of the modal authentication.

The processing execution section may determine a possibility that the execution of the modal authentication is interrupted, and may execute processing for preventing interruption of the execution of the modal authentication if the execution of the modal authentication may be interrupted.

The processing execution section may execute processing in accordance with a relationship between the request of the user suspending the execution of the processing and another request of the user if receiving the other request of the user related to the request of the user suspending the execution of the processing.

The modal authentication executed on the user may be executed by a method in which the user does not need to perform an action for authentication.

The information processing apparatus may include a notification control section that controls notification of information to the user. In this case, the notification control section may suspend (restrict) the notification of the information related to the authentication result of the modal authentication while the execution of the processing in response to the request of the user is suspended.

An information processing method according to an embodiment of the present technology is an information processing method executed by a computer system, and includes acquiring reliability of modal authentication executed on a user.

A reliability threshold is set on the basis of the request of the user.

The execution of the processing in response to the request of the user is suspended until the reliability of the acquired modal authentication becomes larger than the set reliability threshold.

A program according to an embodiment of the present technology causes a computer system to perform the following steps:
obtaining reliability of modal authentication executed on a user;
setting a reliability threshold on the basis of the request of the user; and
suspending execution of processing in response to the request of the user until the reliability of the acquired modal authentication is greater than the set reliability threshold.

### Advantageous Effects of Invention

As described above, according to the present technology, it becomes possible to improve security while exhibiting high usability. Note that the effect described here is not necessarily limited, and may be any of the effects described in the present disclosure.

### BRIEF DESCRIPTION OF DRAWINGS

FIG. 1 is a schematic diagram for explaining an outline of an information processing system according to an embodiment of the present technology.

FIG. 2 is a flowchart for explaining a basic action of the information processing system.

FIG. 3 is a block diagram showing a configuration example of a modal authentication apparatus.

FIG. 4 is a flowchart showing an action example when tracking is executed.

FIG. 5 is a diagram for explaining an outline of an example of user authentication according to the present technology.

FIG. 6 is a block diagram showing a functional configuration example of an agent.

FIG. 7 is a flowchart showing a processing example of the agent with respect to a request of the user.

FIG. 8 is a flowchart showing a processing example of the agent with respect to the request of the user.

FIG. 9 is a flowchart showing a processing example of the agent with respect to the request of the user.

FIG. 10 is a diagram showing an example of determining immediacy and reliability in response to request content of a user.

FIG. 11 is a diagram showing an example of determining the immediacy and the reliability in response to request content of the user.

FIG. 12 shows examples of table information for setting a timeout time and a reliability threshold including a relationship between the immediacy and the reliability.

FIG. 13 is a flowchart showing example processing for determining a possibility that the reliability of modal authentication of the user increases by the timeout time.

FIG. 14 is a table showing a specific example of intermediate processing.

FIG. 15 is a flowchart showing an example of processing for continuing processing performed by the agent.

### MODES FOR CARRYING OUT THE INVENTION

Hereinafter, embodiments of the present technology will be described below with reference to the drawings.

[Configuration of Information Processing System]

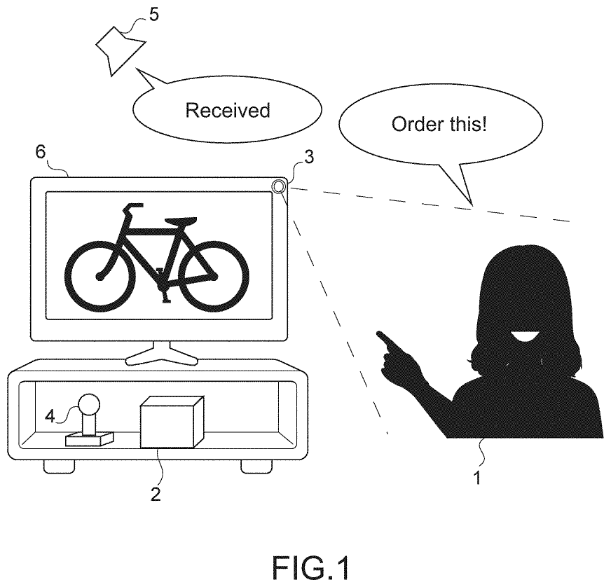

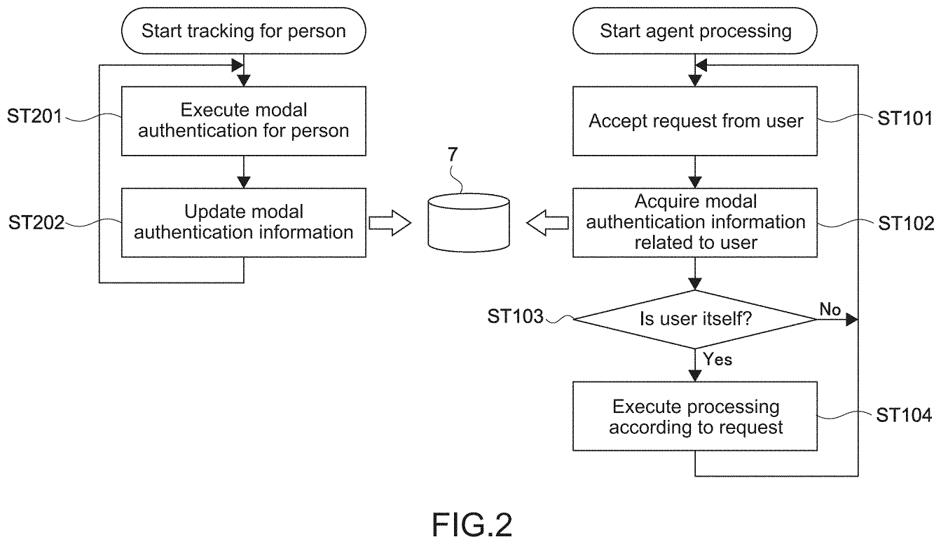

FIG. 1 is a schematic diagram for explaining an outline of an information processing system according to an embodiment of the present technology. FIG. 2 is a flowchart for explaining a basic action of the information processing system.

An information processing system 100 is a system capable of issuing various requests to an interactive agent through voice, gesture, or the like.

The agent is typically constructed by AI (artificial intelligence) which performs deep learning or the like. In the example shown in FIG. 1, the agent 2 is configured in a form visible to the user 1. In the agent 2, a computer system is constructed and functions as an information processing apparatus according to the present technology.

The information processing system 100 includes the agent 2, a camera 3, a microphone 4, a speaker 5, and a television 6. For example, a user 1 speaks “order this!” while pointing to the bicycle displayed on the television 6.

The agent 2 analyzes the image of the user 1 captured by the camera 3 and a voice of the user 1 acquired by the microphone 4. The agent 2 recognizes that the user 1 has entered a request that the user wants to purchase the bicycle displayed on the television 6, and receives the request (Step 101).

Note that the method by which the agent 2 recognizes an item for which the user 1 requested the order is not limited. For example, the agent 2 may be connected to the television 6 via a network, and the currently displayed item may be recognizable. Alternatively, a television screen may be captured and analyzed to recognize the item to which the order is requested.

The agent 2 performs the user authentication for the user 1 who has entered the request. In the present embodiment, modal authentication information related to the user 1 who has input the request is acquired from a storage section 7 included in the information processing system 100 (Step 102).

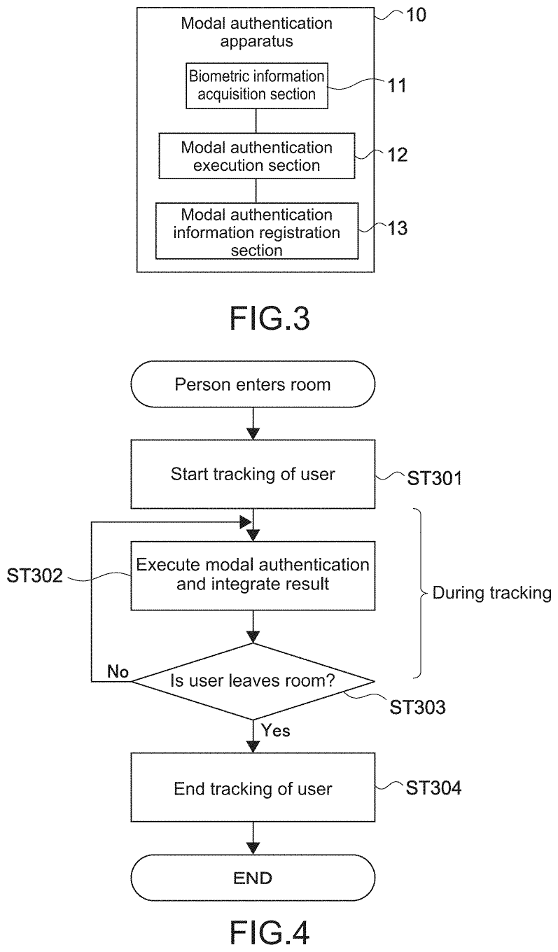

In the present embodiment, the modal authentication information is generated by a modal authentication apparatus 10 (see FIG. 3). For example, when a person is detected in a room or the like, tracking is started for the person, and the modal authentication is executed (Step 201). When the modal authentication is executed, the modal authentication information is generated. While the tracking is being executed, the modal authentication information is updated and registered in the storage section 7 (Step 202). The modal authentication by the modal authentication apparatus will be described in detail later.

On the basis of the modal authentication information acquired from the storage section 7, the agent 2 determines whether or not the user 1 who has input the request is the user itself who is authorized to use the information processing system 100 (Step 103).

When the user 1 who has input the request is the user itself, that is, when the result of the user authentication is valid (Yes in Step 103), the processing in response to the request of the user is executed. In the example shown in FIG. 1, order processing (purchase processing) of the bicycle is executed by the agent 2. At this time, a voice such as “received” or the like may be output via the speaker 5.

If the user 1 who has entered the request is not the user itself (No in Step 103), that is, if the result of the user authentication is invalid, the purchase processing of the bicycle is not executed, and it returns to Step 103. A flow shown in FIG. 2 is a basic action of the user authentication according to the present technology, and the detailed action will be described later.

FIG. 3 is a block diagram showing a configuration example of the modal authentication apparatus 10. FIG. 4 is a flowchart showing an action example when the tracking is executed by the modal authentication apparatus. As described above, in the present embodiment, the modal authentication apparatus 10 performs the modal authentication on the detected person, i.e., the user 1.

The modal authentication is an authentication technique for authenticating the user 1 on the basis of biometric information about the user 1. Examples of biological information about the user 1 include a face, a voice, a fingerprint, a unique action such as a habit, an odor (body odor, halitosis, odor of tobacco or cosmetic), an iris, a wave shape of an electroencephalogram, and the like.

In the present disclosure, authentication using information corresponding to the biometric information is also included in the modal authentication. Such biometric information may include, for example, wearing equipment, clothing, shoes, personal belongings, and ink that is invisible to naked eyes. For a wearing device, information about the device itself may be used, or information related to the device such as user information about the device may be used. The personal belongings include not only an electronic apparatus but also ordinary items. As a method of using ink invisible by a meat source, for example, a method of writing information for identifying a person on a hand or the like can be considered. It should be appreciated that it is not limited thereto, and other information can be included in the biological information or information equivalent to the biological information.

Hereinafter, the biological information and the information equivalent to the biological information will be collectively referred to as biological information. In addition, different types of the biometric information may be represented as different modals.

The modal authentication apparatus 10 includes hardware necessary for configuring a computer such as a CPU, a ROM, a RAM, and an HDD. The CPU loads and executes a program recorded in advance in the ROM or the like into the RAM to realize each block shown in FIG. 3. For example, the modal authentication apparatus can be realized by an arbitrary computer such as a PC. Needless to say, hardware such as an FPGA and an ASIC may be used.

The modal authentication apparatus 10 includes a biometric information acquisition section 11, a modal authentication execution section 12, and a modal authentication information registration section 13.

The biometric information acquisition section 11 acquires the biometric information about the user 1. For example, on the basis of the image of the user 1 taken by the camera 3, the biometric information such as a face, a body type, clothes, and the like of the user 1 is acquired. Voice information about the user 1 is acquired by the voice of the user 1 acquired by the microphone 4 or the like. In addition, a method of acquiring the biometric information is not limited. For example, a dedicated device for acquiring a fingerprint, an electroencephalogram, or the like may be used, and the biometric information may be acquired from the dedicated device.

The modal authentication execution section 12 executes the modal authentication on the basis of the acquired biometric information. For example, the modal authentication is executed by executing matching processing with the biometric information about the user 1 stored in the storage section 7. A specific algorithm or the like for performing the modal authentication is not limited, and, for example, machine learning may be used.

In the present embodiment, by executing the modal authentication, the modal authentication information including an authentication result of the modal authentication and the reliability of the modal authentication is generated. The generated modal authentication information is registered in the storage section 7 by the modal authentication information registration section 13.

The authentication result of the modal authentication includes, for example, information such as “the user 1 is the user itself”, “the user 1 is not the user itself”, “it cannot determine who is the user (Unknown)”, and the like. In the present embodiment, it is recognized that the result of the modal authentication is valid when the authentication result is “the user 1 is the user itself.” If other authentication result is obtained, it is recognized that the result of the modal authentication is invalid (failed).

The reliability of the modal authentication is an index indicating to what degree the authentication result of the modal authentication may be trusted. As shown in FIG. 4, in the present embodiment, when the user 1 enters the room, the tracking of the user 1 is started, and the modal authentication is executed (Step 301).

The modal authentication apparatus 10 is continuously executed until the user 1 leaves the room (loop from Step 302 to No in Step 303). In Step 302, the authentication result of the modal authentication executed during the tracking and the reliability of the modal authentication are appropriately integrated to generate the modal authentication information.

For example, the longer the tracking is continued, the more biometric information about the person can be acquired, and therefore the reliability of the modal authentication is improved. In addition, multiple types of the modal authentication (e.g., facial authentication and voice authentication) can be executed simultaneously, and the reliability of each of the modal authentication can be added together. At this time, weighting may be performed in response to the types of the modal authentication, and the reliability of each may be summed.

A specific method of calculating the reliability of the modal authentication is not limited, and any algorithm may be used. For example, the reliability of the modal authentication is calculated on the basis of accuracy of a matching result between the acquired biometric information and the stored biometric information. Alternatively, the reliability of the modal authentication may be calculated on the basis of content of the acquired biological information, an amount of information, and the like. Alternatively, the reliability of the modal authentication may be calculated using a tracking time for executing the modal authentication as a parameter.

When the user 1 leaves the room (Yes in Step 303), the tracking of the user 1 ends (Step 304). That is, the modal authentication on the user 1 ends. The range in which the tracking is possible is not limited to one room, and the tracking may be possible over a plurality of rooms. Further, it is not limited to an indoor area, and an arbitrary range including an outdoor area may be set as a range in which the tracking is possible.

Note that, in the present embodiment, as the modal authentication to be executed during the tracking, the modal authentication to be executed is selected from a method in which the user 1 does not need to perform an action for authentication. That is, the modal authentication that can be executed on the user 1 performing normal actions in the room, such as the face authentication and the voice authentication, is executed. Thus, it is possible to sufficiently reduce burdens on the user for the modal authentication. Needless to say, it is not limited to the case where such low load modal authentication is executed.

[User Authentication by Agent 2]

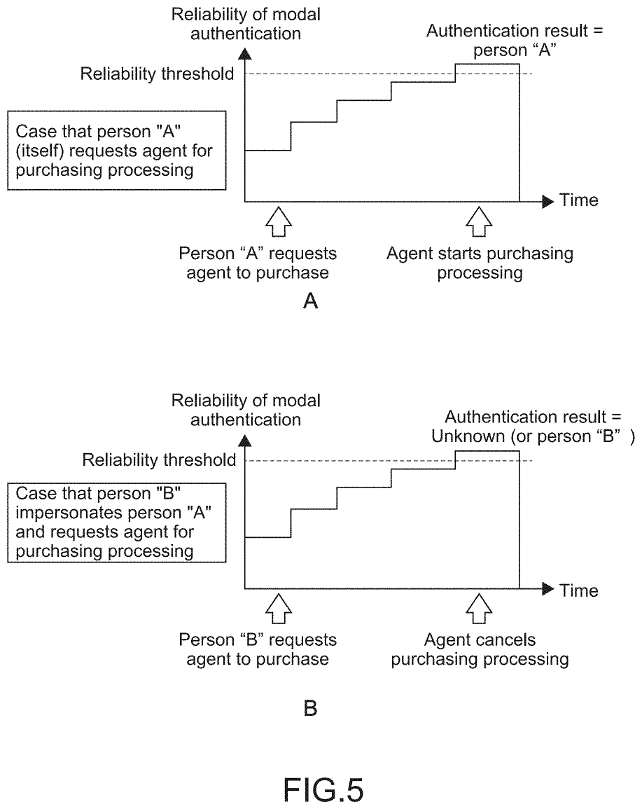

FIG. 5 is a diagram for explaining an outline of an example of the user authentication according to the present technology. FIG. 5A is a diagram showing a case that a person “A” registered in the storage section 7 requests the purchasing processing. As a matter of course, the request for the predetermined processing is included in the request of the user described above.

The agent 2 recognizes that the request has been input from the person “A”, and receives the request. Then, from the storage section 2, the agent 2 reads out the modal authorization information about the person “A” (exactly person corresponding to person “A”). That is, the agent 2 acquires the modal authentication information generated by executing the modal authentication on the person “A”.

As shown in 5A, it is assumed that the reliability of the modal authentication is smaller than the reliability threshold at the time of the request of the person “A”. In this case, on the surface, even though the request of the person “A” is accepted, the execution of the purchase processing in response to the request of the person “A” is suspended. For example, the execution of the processing is suspended while notifying that the request has been received via the speaker 5 or the like. The reliability threshold will be described in detail later.

The agent 2 periodically acquires the modal authentication information about the person “A” from the storage section 7 while the execution of the purchase processing is suspended. Then, it is determined whether or not the reliability included in the acquired modal authentication information is larger than the reliability threshold.

As shown in FIG. 5A, it is assumed that the reliability of the modal authentications is accumulated and becomes larger than the reliability threshold. In this case, the agent 2 executes the processing based on the authentication result of the modal authentication. In FIG. 5A, the authentication result of the modal authentication is the result that the person “A” is the person itself. That is, since the result of the modal authentication is valid, the requested purchase processing is executed as processing in response to the request of the user.

Thus, in the present embodiment, until the reliability of the acquired modal authentication becomes larger than the reliability threshold, the execution of the processing in response to the request of the user is suspended. Note that when the reliability is smaller than the reliability threshold, the authentication result included in the modal authentication information acquired at that time may become invalid.

For example, in a case where the image of the person “A” cannot be properly captured, or in a case where the voice of the person “A” cannot be acquired, the authentication result indicating that the person “A” is the person itself cannot be obtained. In the present embodiment, the user authentication is executed on the basis of the authentication result when the reliability of the modal authentication is sufficiently accumulated. Therefore, it is possible to exhibit very high authentication accuracy and to improve security. In addition, since the user authentication can be executed without requiring the user to do a special action for increasing the reliability, the high usability can be achieved.

FIG. 5B shows a case that a person “B”, a child of the person “A”, impersonates the person “A” and requests the purchasing processing. Assume that the person “B” is not registered in the storage section 7 or is registered but the purchase processing is not permitted.

The agent 2 recognizes that the request has been input from the person “B”, and receives the request. Then, the modal authentication information about the person “B” (more precisely, person corresponding to person “B”) is read out from the storage section 2. That is, the agent 2 acquires the modal authentication information generated by executing the modal authentication with respect to the person “B”.

As shown in FIG. 5B, it is assumed that the reliability of the modal authentication is smaller than the reliability threshold at the time of the request of the person “B”. In this case, the execution of the purchasing processing, which is the processing corresponding to the request of the person “B”, is suspended while the request of the person “B” is accepted on the surface.

The agent 2 periodically acquires the modal authentication information about the person “B” from the storage section 7 while the execution of the purchasing processing is suspended. Then, the agent 2 determines whether or not the reliability included in the acquired modal authentication information is larger than the reliability threshold.

As shown in FIG. 5B, it is assumed that the reliability of the modal authentications is accumulated and becomes larger than the reliability threshold. In this case, the agent 2 executes the processing based on the authentication result of the modal authentication. For example, if the person “B” is not registered, the authentication result of the modal authentication will be (Unknown). If the person “B” is registered, the authentication result is of the person “B”. In any case, since the authentication result of the modal authentication becomes invalid, the request of the user is rejected. Specifically, the purchase processing, which is the processing corresponding to the request of the user, is cancelled, and a warning mode described later is selected.

When the reliability is smaller than the reliability threshold, the authentication result included in the modal authentication information acquired at that time may become undesirably valid. In the present embodiment, the user authentication is executed on the basis of the authentication result when the reliability of the modal authentication is sufficiently accumulated. Therefore, it is possible to sufficiently prevent the impersonation and the like, and high security is exhibited.

Further, for example, when the result of the modal authentication is invalid in a state in which the reliability is not sufficiently accumulated, the request is immediately rejected or the input of an ID/password is newly requested. Then, the person “B”, who tried to impersonate, would immediately perceive that the impersonation is not doing well. As a result, there is a possibility of giving a hint as to how the impersonation succeeds.

In the present embodiment, the execution of the processing is suspended until the reliability is sufficiently accumulated. Therefore, it is possible to prevent the person “B” from sufficiently analyzing what kind of action affects success and failure of the impersonation and correcting the impersonation, and high security is exhibited.

Note that the reliability included in the modal recognition information acquired periodically may be changed. In this case, an average value or the like of the reliability obtained periodically may be newly calculated as the reliability of the modal authentication. Note that when the reliability is generated by the modal authentication apparatus 10, the average value or the like may be calculated based on a history of past reliability or the like, and the average value or the like may be registered in the storage section 7 as the reliability at that point in time.

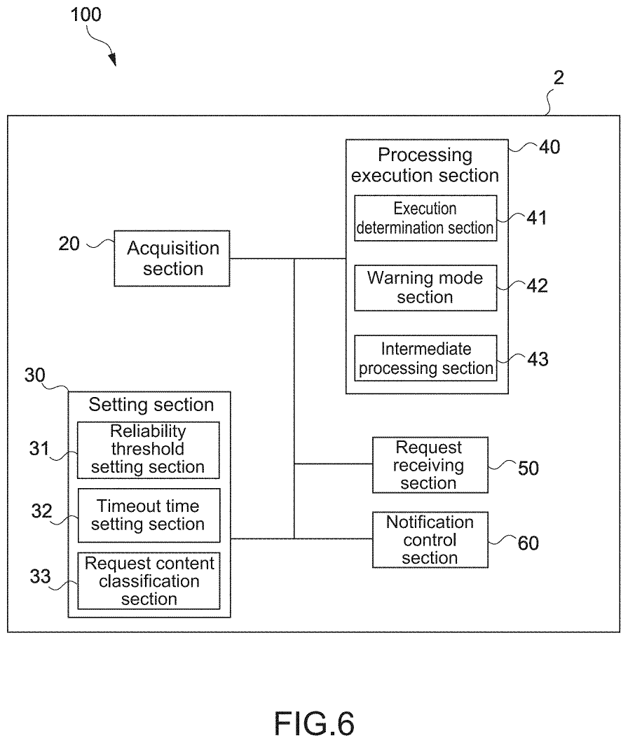

FIG. 6 is a block diagram showing a functional configuration example of the agent 2. The agent 2 includes hardware necessary for the configuration of a computer such as a CPU, a ROM, a RAM, and an HDD, for example.

The CPU loads and executes a program according to the present technology, which is recorded in advance in the ROM or the like into the RAM, whereby the acquisition section 20, the setting section 30, the processing execution section 40, the request reception section 50, and the notification control section 60 are configured as functional blocks, and the information processing method according to the present technology is executed.

For example, the information processing apparatus 100 can be realized by an arbitrary computer such as a PC. Needless to say, hardware such as a FPGA, ASIC may be used. In order to realize each block shown in FIG. 6, dedicated hardware such as an IC (integrated circuit) may be used.

The installation of the program is executed, for example, through various recording media. Alternatively, the installation of the program may be executed via the Internet or the like.

In the present embodiment, the agent 2 is configured as a single device that can be visually recognized. Without being limited to this, the agent may be configured to be incorporated into equipment within a residence, such as an alarm, a fluorescent light, and an interior of a wall, without having a specific enclosure. That is, the agent may be realized in a non-visible configuration.

The acquisition section 20 acquires the modal authentication information from the storage section 7. For example, the acquisition section 20 may calculate the average value or the like of the reliability included in the modal authentication information acquired from the storage section 7, and newly output the calculated average value or the like as the reliability of the modal authentication.

The setting section 30 includes a reliability threshold setting section 31, a timeout time setting section 32, and a request content classification section 33.

The reliability threshold setting section 31 sets the reliability threshold shown in FIG. 5. The reliability threshold is a threshold at which a user's modal authentication reliability is greater than that value to obtain a sufficient authentication result. In the present embodiment, the reliability threshold is set based on the type of the request of the user 1.

The timeout time setting section 32 sets the timeout time. The timeout time is a time that serves as a criterion for determining whether or not to continue suspending of the execution of the processing in response to the request of the user. In the present embodiment, the timeout time is set on the basis of the type of the request of the user 1.

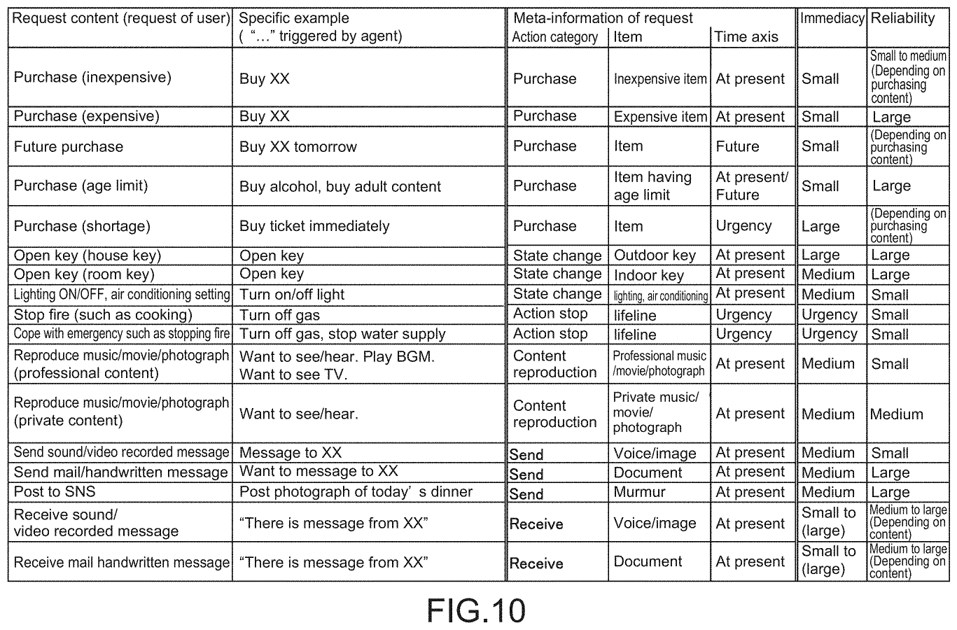

The request content classification section 33 classifies the request on the basis of request content requested by the user 1. A method of classifying in response to the request content will be described later with reference to FIGS. 10 to 12.

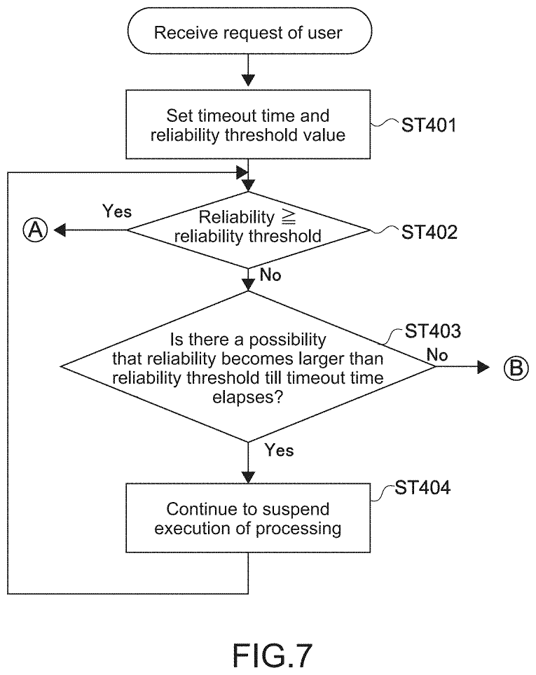

The processing execution section 40 includes an execution determination section 41, a warning mode section 42, and an intermediate processing section 43. Each block will be described with reference to the flowcharts shown in FIGS. 7 to 9.

The request receiving section 50 receives the request input by the user 1. For example, by analyzing the image of the user 1 captured by the camera 3 or the voice of the user 1 acquired by the microphone 4, it is possible to recognize and receive the request of the user. Needless to say, other methods may be executed.

The notification control section 60 controls notification of information to the user 1. Various types of information such as a notification that the request of the user has been accepted are notified. In addition, the notification control section 60 executes to control a notification timing of the information, to restrict or suspend the notification of predetermined information, and the like.

For example, as described with reference to FIG. 5, when the request of the user is accepted on the surface, the notification control section 60 notifies the user of the acceptance via the speaker 5 or the like. While the execution of the processing of the request of the user is suspended, the notification of the information relating to the authentication result of the modal authentication is suspended (restricted). The information about the authentication result of the modal authentication includes, for example, the authentication result of the modal authentication, the fact that the execution of the processing is currently suspended, and the like.

FIGS. 7 to 9 are flowcharts showing a processing example of the agent with respect to the request of the user. When the request of the user 1 is received by the request receiving section 50, the reliability threshold value and the timeout time are set by the reliability threshold value setting section 31 and the timeout time setting section 32 (Step 401).

In the present embodiment, the reliability threshold and the timeout time are set on the basis of the reliability and immediacy set in response to the type of the request of the user. The reliability is set on the basis of the security required to perform the processing in response to the user 1's request. It is also possible that the setting is made in response to the degree to which the user 1 who has input the request is desired to be the user itself.

The immediacy is set on the basis of when it is necessary to execute the processing in response to the request of the user. For example, if the request of the user is urgent or the user has an urgent request, the immediacy is set high. Setting of the reliability threshold and the timeout time based on the reliability and the immediacy will be described below with reference to the various requirements exemplified in FIGS. 10 to 12.

The execution determination section 41 determines whether or not the reliability of the modal authentication is larger than the reliability threshold (Step 402). In the example shown in FIG. 4, it is determined whether or not the reliability is greater than or equal to the reliability threshold, but it may be determined whether or not the reliability is greater than or equal to the reliability threshold.

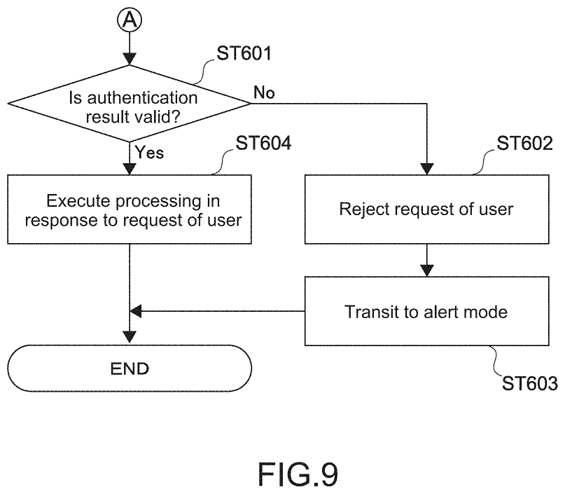

If the reliability of the modal authentication is greater than the reliability threshold (Yes in Step 402), it proceeds to Step 601 in FIG. 9. Then, the execution determination section 41 determines whether or not the authentication result of the modal authentication is valid.

If the authentication result of the modal authentication is valid (Yes in Step 601), the execution determination section 41 executes the processing corresponding to the request of the user 1. If the authentication result of the modal authentication is not valid, that is, is invalid (No in Step 601), the execution determination section 41 rejects the request of the user 1 and cancels the execution of the processing (Step 602).

In addition, the warning mode is selected by the warning mode portion 42, and a mode of the user authentication by the agent 2 is changed to the warning mode (Step 603). The warning mode is a mode in which the execution of the modal authentication with respect to the user 1 is restricted. A restriction of the execution of the modal authentication includes prohibition of the execution of the modal authentication and prohibition of the execution of a predetermined type of the modal authentication.

When the result of the modal authentication is invalid, there is a high possibility that an invalid state such as the impersonation has occurred. On the other hand, there is no possibility that the modal authentication is incorrect. Therefore, in the present embodiment, a mode in which only highly reliable user authentication is valid is set as the warning mode.

For example, in the warning mode, the modal authentication using the biometric information is prohibited. For example, the user authentication is executed by inputting the ID and the password, or the user authentication is executed by inputting an answer to a secret question registered in advance. It should be appreciated that other authentication methods may be employed.

Alternatively, in the warning mode, unreliable modal authentication is prohibited and reliable modal authentication is executed. The reliable modal authentication is modal authentication based on features such as fingerprint authentication and retinal authentication that can reliably identify the user itself.

For example, the authentication such as user's DNAs, a user's palm shape, a user's iris, user's blood vessels, user's handwriting, and user's walking may be employed as the reliable modal authentication. Needless to say, the modal authentication may be executed by combining a plurality of modals.

The warning mode is released when, for example, an administrator of the agent 2 executes a predetermined procedure such as password inputting, or when a preset period has elapsed. At this time, the notification control section 60 may notify the user 1 of the transition to the warning mode. Note that the method of canceling the warning mode is not limited, and the warning mode may be released, for example, in response to a user's utterance to release the warning mode.

Note that the modal authentication in which the user 1 does not need to perform a special action for authentication tends to have low reliability. Conversely, the modal authentication in which the user 1 needs to perform a special action for authentication, tends to have high reliability. Needless to say, by constructing a system for acquiring the biometric information with high accuracy, it is possible to execute highly reliable modal authentication without requiring the user 1 to perform a special action for authentication.

In any case, in the normal mode before the transition to the warning mode, the present inventor gives emphasis to the usability and actively employs the modal authentication in which the user 1 does not need to perform any special action for authentication. In the warning mode, the reliability is emphasized, and the modal authentication is prohibited or only the modal authentication with high reliability is adopted. With such a new idea, high usability and improvement of the security are realized.

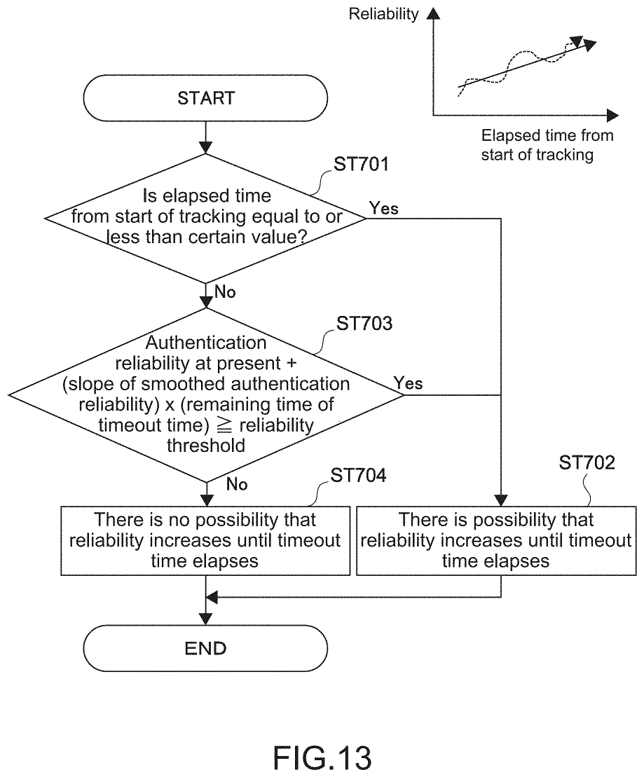

When the reliability of the modal authentication is smaller than the reliability threshold (No in Step 402), the execution determination section 41 determines whether or not the reliability of the modal authentication may become larger than the reliability threshold before the timeout time elapses (Step 403). That is, before the timeout, it is determined whether or not the reliability is expected to exceed the reliability threshold. An example method of executing this step will be described later with reference to FIG. 13.

If the result of the determination in Step 403 is affirmative (Yes in Step 403), the execution determination section 41 continues to suspend the execution of the processing in response to the request of the user 1 is continued (step 404). This is equivalent to continuing the modal authentication by the tracking and waiting for the reliability to accumulate.

If the result of the determination in Step 403 is denied (No in step 403), the intermediate processing section 43 executes intermediate processing for increasing the reliability of the modal authentication. The intermediate processing includes, for example, various processing including requesting the user to take action to increase the reliability of the modal authentication.

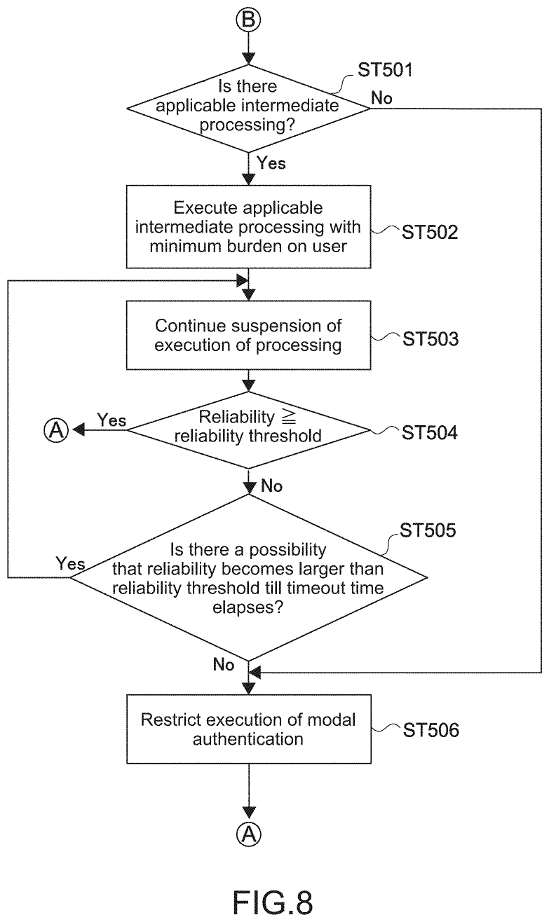

As shown in FIG. 8, in the present embodiment, the intermediate processing section 43 first determines whether or not there is an applicable intermediate processing (Step 501). For example, it is determined whether or not there is an applicable intermediate processing on the basis of the type of user request, the type of modal required, the status of the user, the surrounding status, and the like.

If there is no applicable intermediate processing (No in Step 501), the execution determination section 41 restricts the execution of the modal authentication on the user 1 (Step 506). That is, similar to the warning mode, the modal authentication is prohibited or only the modal authentication with high reliability is executed with emphasis on reliability. The same authentication method as the warning mode may be employed, or an authentication method different from the warning mode may be employed.

By employing so-called commonly used authentication methods (such as entering ID and password), it is possible to authenticate the user in a way familiar to the user and to prevent the usability from lowering.

If there is an applicable intermediate processing (Yes in Step 501), the intermediate processing section 43 executes the intermediate processing with the minimum burden on the user (Step 502). In this way, in the present embodiment, the intermediate processing is appropriately selected on the basis of the degree of burden on the user when performing an action required for the user in order to increase the reliability of the modal authentication. This makes it possible to maintain high usability.

When the intermediate processing is executed, the suspending of the execution of the processing in response to the request of the user 1 is continued (Step 503). It is then determined whether or not the reliability of the modal authentication is greater than the reliability threshold (Step 504). If the reliability of the modal authentication is greater than the reliability threshold (Yes in Step 504), the processing proceeds to step 601 in FIG. 9.

If the reliability of the modal authentication is less than the reliability threshold (No in Step 504), it is determined whether or not the reliability of the modal authentication is possible to become greater than the reliability threshold before the timeout time has elapsed (Step 505). If the result of the determination in Step 505 is affirmative (Yes in Step 505), it returns to Step 503.

If the result of the determination in Step 505 is denied (No in Step 505), the execution of the modal authentication on the user 1 is restricted (Step 506).

Note that in the flows shown in FIGS. 7 to 9, the possibility that the reliability of the modal authentication becomes larger than the reliability threshold before the timeout time elapses is determined, and the execution of the modal authentication is restricted when the possibility does not exist. Thus, the user can realize high usability by reducing the waiting time in which the reliability of the modal authentication is accumulated until the timeout time.

It should be noted that there may be a method in which the step of determining the possibility that the reliability of the modal authentication becomes larger than the reliability threshold is not performed. In this case, if the timeout time elapses before the reliability of the modal authentication becomes larger than the reliability threshold, the execution of the modal authentication on the user is restricted. Also, there may be a method in which no intermediate processing is executed. In this case, when there is no possibility that the reliability of the modal authentication becomes larger than the reliability threshold before the timeout time elapses, the execution of the modal authentication on the user is restricted.

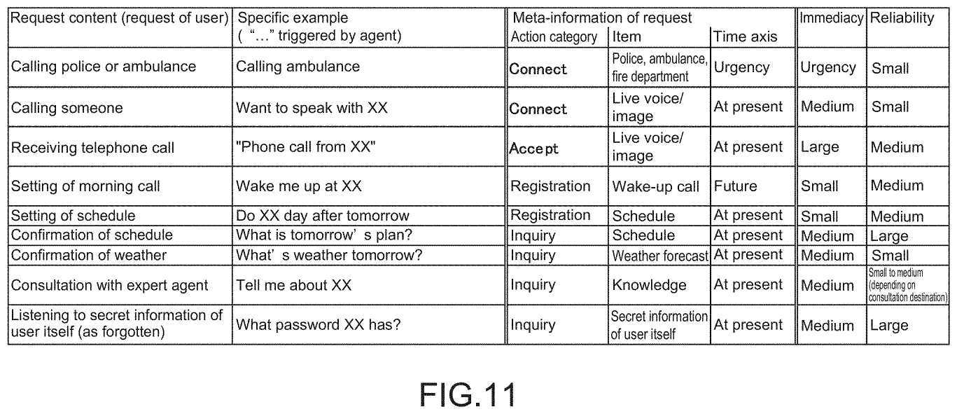

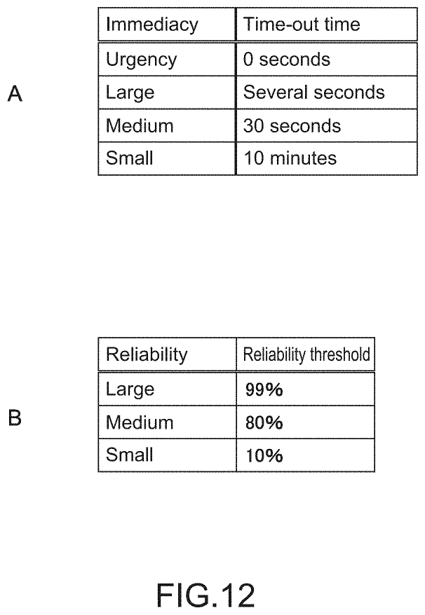

FIG. 10 and FIG. 11 are diagrams showing an example of determining the immediacy and reliability in response to the request content (request type) of the user. FIG. 12 is examples of table information including a relationship between the immediacy and the timeout time and between the reliability and the reliability threshold.

As shown in FIG. 7, when the request of the user 1 is received by the request receiving section 50, the reliability threshold value and the timeout time are set by the reliability threshold value setting section 31 and the timeout time setting section 32 (Step 401). Hereinafter, a specific example of the processing of Step 401 will be described with reference to FIGS. 10 to 12.

In the present embodiment, the request content classifying section 33 shown in FIGS. 10 and 11 classifies the request of the user 1 on the basis of “action category”, “item”, and “time axis”. More specifically, meta-information about each of “action category”, “item”, and “time axis” is set in response to the type of the request of the user 1.

The “action category” is for an action requested by the user 1, and the meta-information such as purchasing, a state change, content reproduction, transmission (send), reception (Receive), connection (connect), reception (accept), registration, inquiry, etc. is set, for example.

The “item” is an item of the requested action, and meta-information such as, for example, an inexpensive item, an expensive item, an item having an age limit, a key, lighting, a lifeline, a photograph, music, a murmur, a sentence, a police (report destination), a schedule, a weather forecast, etc. is set.

The “time axis” is a time (timing) at which the requested action is performed, and meta-information such as present, future, urgency, etc. is set, for example. Needless to say, the meta-information about “action category”, “item”, and “time axis” is not limited to those described above or shown in FIGS. 10 and 11. Also, parameters for classifying the request of the user 1 are not limited, and for example, parameters different from “action category”, “item”, and “time axis” may be adopted.

The request content classification section 33 sets the immediacy and the reliability on the basis of the meta-information about “action category”, “item”, and “time axis” set in response to the type of the request of the user 1. The setting method is not limited, and any algorithm may be used.

In Step 401 shown in FIG. 7, the reliability threshold setting section 31 and the timeout time setting section 32 set the reliability threshold and the timeout time with reference to the table information shown in FIGS. 12A and 12B on the basis of the immediacy and the reliability set in response to the type of the request of the user 1. In the present embodiment, the request content classifying section 33 functions as a part of the setting section. Note that the table information shown in FIGS. 12A and 12B is an example, and a specific value of the timeout time for the immediacy, a specific value of the reliability threshold for the reliability, and the like may be arbitrarily set.

Hereinafter, with reference to FIGS. 10 and 11, a specific example of setting the classification of the requests from the user 1 (setting of meta information), the immediacy, and the reliability will be described.

About the setting of the reliability, for example, when the user 1 requests the agent 2 to purchase an expensive item, unlock the key of the house of the user 1, confirm the schedule of the user 1, and the like, the reliability is set to “large” because it is highly necessary for the user 1 itself. As a result, the reliability threshold is set to 99%.

If the content requested by user 1 is not required for the user 1 itself, such as raising the temperature of the room, the reliability is set to “small”. As a result, the reliability threshold is set to 10%.

About the setting of the immediacy, for example, when the user 1 requests the purchase of a commodity having a small number of items or the reception of a telephone call, the immediacy is set to “large” because it is urgent. As a result, the timeout period is set to a few seconds.

When the content requested by the user 1 does not need to execute the processing immediately such as setting the schedule, the immediacy is set to “small”. As a result, the timeout period is set to 10 minutes.

In the case of an emergency such as stopping a fire during cooking or calling a police or an ambulance, the reliability is set to “small”, the immediacy is set to “urgent”, the reliability threshold is set to 10%, and the timeout time is set to 0 seconds. In the case of urgency, the reliability is set to “zero” and the reliability threshold is set to 0%, and the request may be executed without authenticating the person.

Thus, by obtaining the reliability and the immediacy for the content of the request of the user 1 and setting the reliability threshold and the timeout time, the agent 2 can respond to the request of the user 1 without compromising the usability and the security of the user 1.

Referring to FIG. 10, for the purchase of inexpensive items, meta-information of “purchase”, “inexpensive items” and “at present” is set, and correspondingly, the reliability is set to “small to medium” and the immediacy is set to “small” in accordance with the content of the purchased items. As a result, the reliability threshold is set at 10-80% and the timeout is set at 10 minutes.

For the purchase of expensive items, the meta-information of “purchase”, “expensive items” and “at present” is set, and the reliability is set to “large” and the immediacy is set to “small” in correspondence with the meta-information of “purchase”, “expensive items” and “at present”. As a result, the reliability threshold is set at 99% and the timeout is set at 10 minutes.

For the purchase of items needed tomorrow, the meta-information of “purchase”, “items” and “future” is set, the reliability is set in response to the content of the purchased items, and the immediacy is set to “small”. As a result, the reliability threshold is set in response to the content of the purchased item, and the timeout time is set to 10 minutes.

For purchase of age-limited items, meta-information of “purchase”, “age-limited items”, and “at present/future” is set, and the reliability is set to “large” and the immediacy is set to “small” correspondingly. As a result, the reliability threshold is set at 99% and the timeout is set at 10 minutes.

For the purchase of shortage items, meta-information of “purchase”, “items”, and “emergency” is set, the reliability is set in response to the content of the purchased items, and the immediacy is set to “large”. As a result, the reliability threshold is set in response to the content of the purchased item, and the timeout time is set to 0 seconds.

The meta-information about “state change”, “outdoor key” and “at present” is set to open the key of the house, and the reliability is set to “large” and the immediacy is set to “large” correspondingly. As a result, the reliability threshold is set to 99% and the timeout period is set to a few seconds.

For unlocking a room, the meta-information about “state change”, “indoor key” and “at present” is set, and the reliability is set to “large” and the immediacy is set to “medium” correspondingly. As a result, the reliability threshold is set at 99% and the timeout time is set at 30 seconds.

The meta-information about “state change”, “lighting, air conditioning” and “at present” is set to change lighting or air conditioning, and the reliability is set to “small” and the immediacy is set to “medium” correspondingly. As a result, the reliability threshold is set at 10%, and the timeout time is set at 30 seconds.

The meta-information about “action stop”, “life line” and “emergency” is set in response to an emergency request such as stopping a fire, and the reliability is set to “small” and the immediacy is set to “emergency” correspondingly. As a result, the reliability threshold is set at 10%, and the timeout time is set at 0 seconds.

The meta-information about “content reproduction”, “professional music/movie/photograph”, and “at present” is set for the reproduction of professional music, movie and photograph, and the reliability is set to “small” and the immediacy is set to “medium” correspondingly. As a result, the reliability threshold is set at 10%, and the timeout time is set at 30 seconds.

The meta-information about “content reproduction”, “private music/movie/photograph”, and “at present” is set for reproduction of private music, movie, and photograph, and the reliability is set to “medium” and the immediacy is set to “medium” correspondingly. As a result, the reliability threshold is set at 80% and the timeout time is set at 30 seconds.

The meta-information about “send”, “voice/image”, and “at present” is set for sending voice/video recorded messages, and the reliability is set to “small” and the immediacy is set to “medium” accordingly. As a result, the reliability threshold is set at 10%, and the timeout time is set at 30 seconds.

The meta-information about “send”, “document”, and “at present” is set for sending mail/handwritten messages, and the reliability is set to “large” and the immediacy is set to “medium” correspondingly. As a result, the reliability threshold is set at 99% and the timeout time is set at 30 seconds.

The meta-information about “send”, “meta-information of “send”, “murmur”, and “at present” is set for posting to the SNS, and the reliability is set to “large” and the immediacy is set to “medium” correspondingly. As a result, the reliability threshold is set at 99% and the timeout time is set at 30 seconds.

The meta-information about “Receive”, “voice/image”, and “at present” is set for receiving a voice/video recorded messages, and the reliability is set to “medium to large” in response to the content, and the immediacy is set to “small to large” in response to the content correspondingly. As a result, the reliability threshold is set to 80-99% in response to the content, and the timeout time is set to several seconds to 10 minutes in response to the content.

The meta-information about “Receive”, “document”, and “at present” is set for receiving mail/handwritten messages, and the reliability is set to “medium to large” in response to the content, and the immediacy is set to “small to large” in response to the content correspondingly. As a result, the reliability threshold is set to 80-99% in response to the content, and the timeout time is set to several seconds-10 minutes in response to the content.

Referring to FIG. 11, the meta-information about “connect”, “police, emergency, firefighting”, and “emergency” is set for calling a police, an ambulance, or the like, and the reliability is set to “small” and the immediacy is set to “emergency” correspondingly. As a result, the reliability threshold is set to 10%, and the timeout time is set to 0 seconds.

The meta-information about “connect”, “live voice/image”, and “at present” is set for calling someone, and the reliability is set to “small” and the immediacy is set to “medium” correspondingly. As a result, the reliability threshold is set at 10%, and the timeout time is set at 30 seconds.

The meta-information about “accept”, “live voice/image”, and “at present” is set for receiving a call, and the reliability is set to “medium” and the immediacy is set to “large” correspondingly. As a result, the reliability threshold is set at 80% and the timeout period is set at several seconds.

The meta-information about “registration”, “wake-up call”, and “future” is set for the setting of the wake-up call, and the reliability is set to “medium” and the immediacy is set to “small” correspondingly. As a result, the reliability threshold is set at 80% and the timeout is set at 10 minutes.

The meta-information about “registration”, “schedule”, and “at present” is set for the setting of the schedule, and the reliability is set to “medium” and the immediacy is set to “small” correspondingly. As a result, the reliability threshold is set at 80% and the timeout is set at 10 minutes.

The meta-information about “inquiry”, “schedule” and “at present” is set for confirmation of the schedule, and the reliability is set to “large” and the immediacy is set to “medium” correspondingly. As a result, the reliability threshold is set at 99% and the timeout time is set at 30 seconds.

The meta-information about “inquiry”, “weather forecast”, and “at present” is set for confirmation of weather, and the reliability is set to “small” and the immediacy is set to “medium” correspondingly. As a result, the reliability threshold is set at 10%, and the timeout time is set at 30 seconds.

The meta-information about “inquiry”, “knowledge”, and “at present” is set for consultation with an expert agent, and the reliability is set to “small to medium” in response to consultation and the immediacy is set to “medium” correspondingly. As a result, the reliability threshold is set to 10-80% in response to the consultation destination, and the timeout time is set to 30 seconds.

Here, the expert agent refers to an agent specialized in a specific field such as travel consultation. Consulting is performed for the expert agent via the Internet or the like.

The meta-information of “inquiry”, “personal secret information”, and “at present” is set for listening to the secret information of the user 1 such as a password, and the reliability is set to “large” and the immediacy is set to “medium” correspondingly. As a result, the reliability threshold is set at 99% and the timeout time is set at 30 seconds.

In this way, in the present embodiment, the reliability threshold and the timeout time corresponding to the type of the request of the user 1 are set on a rule basis. Without being limited to this, the reliability threshold value and the timeout time may be set on a machine learning basis. For example, the reliability threshold value and the timeout time may be output by the machine learning using the meta-information about the request of the user 1 as an input. Any other methods may be employed.

FIG. 13 is a flowchart showing example processing for determining a possibility that the reliability of the modal authentication of the user increases by the timeout time. That is, this is the example processing executed by the execution determination section 41 in Step 403 of FIG. 7 or Step 505 of FIG. 8.

The graph shown in the upper right of FIG. 13 is a graph schematically showing a state in which the reliability of the modal authentication accumulates. The dotted line in the graph represents an actual change of the reliability, and the solid line represents smoothed reliability. As described below, in the present embodiment, by smoothing the reliability, it is determined whether or not the reliability of the modal authentication may become larger than the reliability threshold before the timeout time elapses.

It is determined whether or not the elapsed time from the start of the tracking is equal to or less than a certain value (Step 701). If the elapsed time is less than or equal to the certain value (Yes in Step 701), and there is a time until the timeout time elapses, it is determined that there is a possibility that the reliability of the modal authentication increases before the timeout time elapses (Step 702).

When the elapsed time exceeds the predetermined value (No in Step 701), it is determined whether or not the value obtained by adding (reliability of modal authentication of user 1 at present)+(slope of reliability of modal authentication of smoothed user 1)×(remaining time until timeout time) becomes larger than the reliability threshold value.

If the result of the determination in Step 703 is affirmative (Yes in Step 703), it is determined that the reliability of the modal authentication may increase before the timeout time elapses (step 702).

If the result of the determination in Step 703 is denied (No in Step 703), it is determined that there is no possibility that the reliability of the modal authentication increases before the timeout time elapses (Step 704).

The reason why the reliability of the modal authentication of the user 1 is smoothed is that the reliability of the modal authentication of the user 1 obtained by the tracking varies depending on the direction in which the face of the user 1 directs, even if the modal authentication of the same face is performed. Thus, even in various states of the user, it is possible to improve the accuracy of the user authentication and improve the security.

By smoothing, the reliability of the modal authentication of the user 1 increases by several percent per second, to thereby obtaining a slope. Depending on the degree of the slope, it is determined whether or not the reliability of the modal authentication of the user 1 becomes larger than the reliability threshold by the timeout time.

For example, it is assumed that the reliability of the modal authentication of the user 1 at present is 10%, and the slope of the reliability of the modal authentication of the smoothed user 1 is increased by 8% per second. In this case, if the timeout period is 10 seconds, it is assumed that the reliability of the modal authentication of the user 1 may increase to 90% by the timeout period.

At this time, when the reliability threshold value set by the reliability threshold setting section 31 is set is 80%, it is determined that the reliability of the modal authentication of the user 1 by the timeout time may be greater than the reliability threshold, and the certification of the user 1 is continued.

In addition, if the slope of the reliability of the modal authentication of the smoothed user 1 increases by 5% per second, the reliability of the modal authentication of the user 1 is 60% by the timeout time. In this case, the execution determination section 41 determines that there is no possibility that the reliability of the modal authentication of the user 1 becomes larger than the reliability threshold by the timeout time.

At present, when the reliability of the modal authentication of the user 1 is low and the slope of the reliability of the modal authentication of the smoothed user 1 is small, and if it is determined that the reliability of the modal authentication of the user 1 does not exceed the reliability threshold by the timeout time, the execution determination section 41 can proceed to the next step without waiting until the timeout time. As a result, the user's waiting time can be reduced and high usability can be achieved.

Although the reliability of the modal authentication of the smoothed user 1 is represented by a linear function as shown in FIG. 13, which is not limited thereto, the authentication reliability of the modal authentication of the user may be increased by a slope of a quadratic function or the like. It should be noted that any other methods may be used to smoothen the reliability to determine whether or not the reliability of the modal authentication may be greater than the reliability threshold before the timeout time has elapsed.

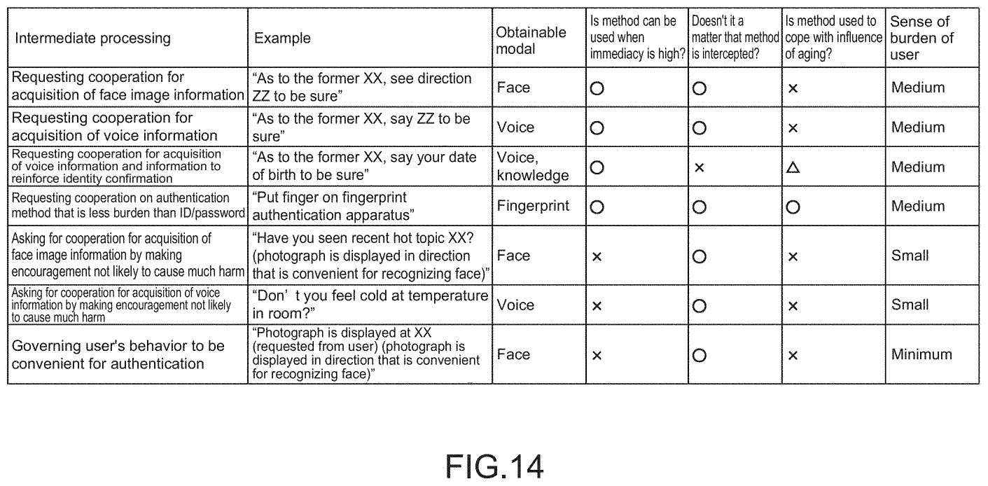

FIG. 14 is a table showing a specific example of the intermediate processing. When the result of the determination in Step 501 is affirmative (Yes in Step 501), the intermediate processing section 43 selects the intermediate processing applicable to the user 1 in Step 502, which has the smallest sense of burden (degree of burden) of the user 1. Hereinafter, a selection example of the intermediate processing by the intermediate processing section 43 will be described in detail.

In the table of FIG. 14, evaluation parameters indicating the characteristics for the intermediate processing are described. In the present embodiment, as evaluation parameters, “obtainable modal”, “is method can be used when immediacy is high?”, “doesn't it a matter that method is intercepted?”, “is method used to cope with influence of aging?”, and “sense of burden of user” are set.

The obtainable modal is the modal obtained by the intermediate processing to be executed. For example, if the modal required to increase the reliability of the modal authentication of the user 1 is specified, this evaluation parameter is referenced to select the appropriate intermediate processing.

The method that can be used when the immediacy is high is the intermediate processing in which the reliability of the modal authentication of the user 1 can be increased, even when the timeout time set based on the request of the user 1 is short (or remaining time is short.

The method that doesn't the matter if it is intercepted is the intermediate processing in which the personal information about the user 1 is not leaked, even if the interaction between the agent 2 and the user 1 by the intermediate processing to be executed is viewed by the other party.

The method that is used to cope with the influence of aging is the intermediate processing that is executed by a method that has little influence on the aging of the user 1 in a case where the month and day have elapsed since the agent 2 authenticated the user 1.

Referring to FIG. 14, the intermediate processing for requesting cooperation for acquisition of face image information is the modality in which a “face” can be acquired. In addition, since it is possible to turn the face immediately, the immediacy is high, and in particular, since personal information is not leaked, the method doesn't the matter if it is intercepted. On the other hand, since the face is influenced by aging, it cannot be used to cope with the influence of aging. The user's sense of burden becomes medium because it makes the face of the user to be directed.

The intermediate processing for requesting cooperation for acquisition of the voice information is the modal in which the “voice” can be acquired. In addition, since it is possible to immediately speak, the immediacy is high and it can be used as a method that doesn't the matter if it is intercepted by appropriately selecting the content to be spoken. On the other hand, the voice is influenced by aging, so it cannot be used to cope with the influence of aging. The user's sense of burden is medium.

The intermediate processing for requesting cooperation for acquisition of the voice information and information to reinforce identity confirmation is a modal in which “voice, knowledge” can be acquired. It can also be used as an the immediacy method because it can be spoken immediately. With regard to countermeasures against the influence of aging, the voice itself is influenced by aging, but the knowledge itself is almost not influenced by aging, so that it is possible to cope with it to some extent by appropriately selecting the content to be spoken. On the other hand, knowledge is intercepted when there is another person, so it cannot be used in the method that doesn't the matter if it is intercepted. The user's sense of burden is medium.

The intermediate processing that requests cooperation on the authentication method that is less burden than the ID/password is a modal in which fingerprint authentication is assumed and fingerprints can be acquired. In addition, since a fingerprint authentication apparatus can be touched immediately, the immediacy is high and can be used as a method that does not influence the effect of aging. The user's sense of burden is medium. Note that there may be methods other than the fingerprint authentication.

The intermediate processing that asks for cooperation for acquisition of the face image information by making encouragement not likely to cause much harm is a modal in which “face” can be obtained. Furthermore, it doesn't the matter to view the face by other person and it can be used as an interception method. On the other hand, since the face is influenced by aging, it cannot be used to cope with the influence of aging. In addition, since the recognition of the face may take a long time, it cannot be used when the immediacy is high. The user's sense of burden is small.

The intermediate processing that asks for cooperation for acquisition of the voice information by making encouragement people to do so is a modal in which “voice” can be acquired. In addition, it can be used as a method that doesn't the matter if it is intercepted by appropriately selecting contents that may be heard by another person. On the other hand, the voice is influenced by aging, so it cannot be used to cope with the effects of aging. In addition, since it may take a long time to recognize a voice, it is not possible to use the voice in a case where the immediacy is high. The user's sense of burden is small.

The intermediate processing that governs the user's behavior to be convenient for authentication is a modal from which the “face” can be obtained. Furthermore, it doesn't the matter to view the face by other person and it can be used as an interception method. On the other hand, since the face is influenced by aging, it cannot be used to cope with the effects of aging. Also, it may be necessary to wait for an event that is convenient for authentication to happen, and it cannot be used if the immediacy is high. The user's sense of burden is minimum.

Among the intermediate processes classified as above, examples will be described in which the intermediate processing section 43 is applicable and the user's sense of burden is minimal.

As a first example, suppose that the user 1 requests the agent 2 to buy an “expensive item” in a voice. Although the agent 2 hears the voice of the user 1 but a face direction is not good, the reliability of the modal authentication is low and the agent 2 determines that the reliability of the modal authentication of the user 1 may not exceed the reliability threshold by the timeout time, and executes the intermediate processing.

The agent 2 determines that the immediacy is low because the content of the request of the user 1 corresponds to “purchase” an “expensive item”. The agent 2 further acquires the face information about the user 1, and determines that the reliability of the modal authentication of the user 1 is improved. From these decisions, it is possible for the agent 2 to select “governing the user's behavior in a manner convenient for authentication” in FIG. 14, but it is difficult to “govern the user's behavior in a manner convenient for authentication” here. In this case, the agent 2 selects “Asking for cooperation for acquisition of face image information by making encouragement not likely to cause much harm”.

On the basis of the above, the agent 2 displays the photo in a convenient direction to recognize the face of the user 1. By viewing the displayed photo by the user 1, the user 1 can increase the reliability of the modal authentication of the user 1 without being aware of the special action for authentication, that is, by authentication with a small sense of burden.

A second example is a situation in which the agent 2 is unable to identify the person in the room when it detects that the agent 2 has received a telephone call. At this time, the agent 2 determines that there is no possibility that the reliability of the modal authentication of the person exceeds the reliability threshold by the timeout time, and the intermediate processing is executed.

In this case, the agent 2 determines that the immediacy is high because it corresponds to “Receive a call” in FIG. 11. The agent 2 further acquires the face information of the user 1, and determines that the reliability of the modal authentication of the user 1 is improved. At this time, if there is no means for specifying the user 1, such as the fingerprint authentication apparatus, and if a camera is attached to a television screen, the agent 2 determines that it is optimal to acquire a face image.

As described above, the agent 2 selects “request cooperation for acquisition of face image information” in FIG. 14. On the basis of the above, the agent 2 instructs the person to face in a direction that is convenient for recognizing the user's face. The reliability of the modal authentication of the user 1 can be enhanced by looking at the specified direction.

In the case of the second example, when the person impersonates the user 1, the instruction issued by the agent 2 teaches that the authentication result is not certain. However, since the immediacy is high, the timeout time is short, and a time to correct the impersonation by the user 1 is not enough, the security is improved.

Note that the content of the intermediate processing, the method of selecting the applicable intermediate processing, the method of setting the evaluation parameter, and the like are not limited thereto, and may be arbitrarily set. Any algorithm other than the obtainable modality, the method that can be used when the immediacy is high, the method that doesn't the matter if it is intercepted, the method that can be used to cope with the effects of aging, and the sense of burden on the user shown in FIG. 14 may be employed. In addition, the agent 2 may appropriately change the information by using the machine learning such as deep learning in accordance with the content of the request or the tendency of the user 1.

As described above, in the information processing apparatus 100 according to the present embodiment, the reliability of the modal authentication executed on the user 1 is acquired, and the reliability threshold is set based on the request of the user 1. Until the reliability of the modal authentication becomes larger than the reliability threshold, the execution of the processing in response to the request of the user 1 is suspended. This makes it possible to improve security while exhibiting high usability.

For example, in a case where the reliability of the modal authentication is smaller than the reliability threshold, the processing is suspended until the reliability of the modal authentication of the user is sufficiently accumulated, rather than immediately requiring the user to perform normally authentication such as an ID/password input. This reduces the frequency of forcing the user authentication, which is a special burden for the user to authenticate, and enables to exhibit high usability.

In addition, in a case where the reliability of the modal authentication is smaller than the reliability threshold and the user authentication such as the ID/password input is requested, there may be a hint that the reliability is insufficient for the person who attempted to impersonate. In the present embodiment, by not displaying the fact that the processing for the request is suspended on the UI or the like, it is possible to prevent the person who attempted the impersonation from performing the impersonation such as mimicking the user's own habit, and it is possible to earn time for continuing the modal authentication. As a result, the security can be improved.

In the present embodiment, in a case where the authentication result of the modal authentication is not the user itself, the warning mode is selected by the warning mode section 42 in consideration of the possibility that an unspecified person has attempted to impersonate. As a result, it is possible to improve the security because it restricts procedures other than the reliable modal authentication such as the retinal authentication and the predetermined procedures such as the password input.

### Other Embodiments

The present technology is not limited to the embodiments described above, and various other embodiments can be realized.

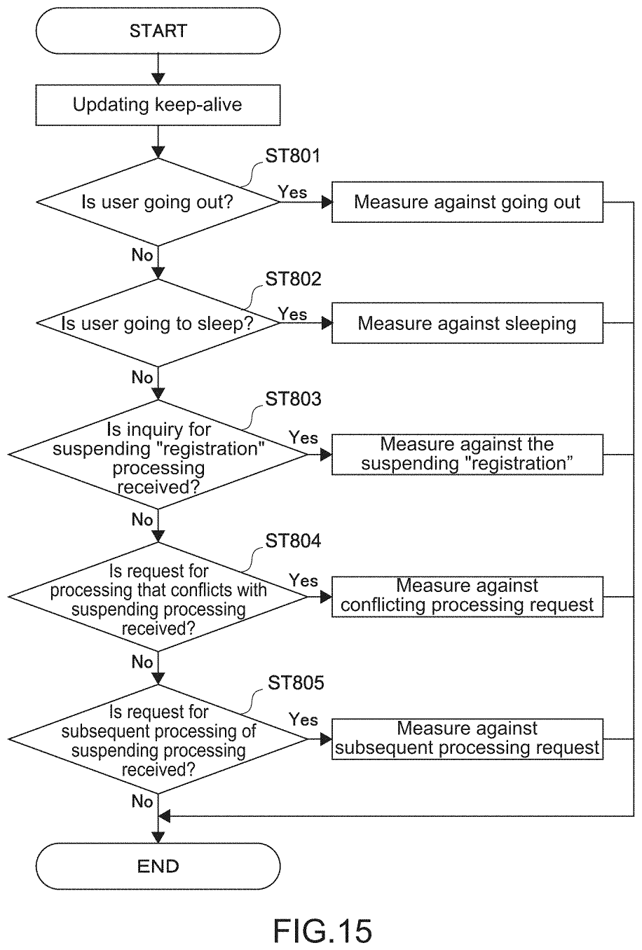

FIG. 15 is a flowchart showing an example of processing for continuing the processing performed by the agent 2. This flowchart assumes that when the request of the user 1 is suspended, the agent 2 cannot continue the authentication, or that the suspended request interferes with newly request content.

“Updating keep-alive” in FIG. 15 is a measure taken when the agent 2 cannot continue the action due to a power failure or the like while the agent 2 suspends the request of the user 1.

Keep-alive means that agent 2 periodically notifies a server device such as a cloud service of a present status such as a present time. Thus, when the keep-alive from the agent 2 is interrupted while the request of the user 1 is suspended, the server device determines that the agent 2 cannot continue the action, authenticates the user 1, and can take over the process of the agent 2.

In a case where the agent 2 detects the action of the user 1 to go out while the authentication is continued, the agent 2 takes a measure against going out (Yes in Step 801).

The measures against going out is taken assuming that while the agent 2 is suspending the request of the user 1, the user 1 goes out of a trackable range and continuous tracking becomes difficult.

For example, in a case where the agent 2 detects an event in which the user 1 is to leave the room or the house, the agent 2 calls to stop the user 1 before the user 1 exits and performs the reliable user authentication such as the ID/password input, and the processing proceeds to the flowchart of FIG. 9.

In a case where the agent 2 detects that the user 1 is not going out (No in Step 801) but is going to sleep, the agent 2 takes a measure against sleeping (Yes in Step 802).

The measure against sleeping is a measure assuming that when the user 1 goes to sleep, the agent 2 cannot obtain the modal authentication of the user 1 such as voice, and it is difficult to improve the reliability of the authentication result of the modal authentication of the user 1.

For example, when the agent 2 detects a sign that the user 1 goes to sleep, the agent calls the user 1 before the user goes to sleep, prompts for the reliable user authentication such as the ID/password input, and proceeds to the flowchart of FIG. 9.

In a case where the agent 2 receives not a sleeping action (No in Step 802) but an inquiry for the suspending “registration” processing, the agent 2 takes a measure against the suspending “registration” (Yes in Step 803).

The measure against suspending “registration” is a measure that assumes that the user makes an inquiry to the agent regarding the “registration” while the agent 2 is suspending the processing in which the request of the user 1 is the “registration” of the action category.

For example, it assumes that if the agent 2 has suspending a request to register a schedule for tomorrow of the user 1, the user 1 requests the agent 2 to confirm a schedule for tomorrow. In such a case, the registration of the pending schedule is returned as registered. After the agent responds, the agent prompts the user 1 for the reliable user authentication such as the ID/password input, and proceeds to the flowchart of FIG. 9.

In a case where the agent 2 receives not the inquiry (No in Step 803) but a request for processing that conflicts with the suspending processing, the agent 2 takes a measure against the request for the conflicting processing (Yes in Step 804).

The measure against the request for the conflicting processing is a measure assuming that a new request is requested that conflicts or is incompatible with the suspending request while the agent 2 is suspending the request of the user 1.

If the agent 2 receives the request that overlaps with the suspending request, the agent 2 rejects the request received later. For example, there may be a case that the user 1 requests the agent 2 to lower the temperature of the room and the user 1 again requests to lower the temperature of the room while the agent 2 is suspending the processing of the request.

If the agent 2 receives the request that is difficult to be compatible with the suspending request, the agent 2 inquires the user 1 which request is to be processed. At this time, if the reliability of the authentication result of the modal authentication of the user 1 exceeds the reliability threshold, the processing proceeds to the flowchart of FIG. 9. If the reliability of the authentication result of the modal authentication of the user 1 does not exceed the reliability threshold, the highly reliable user authentication such as the ID/password input is performed, and it proceeds to the flow chart of FIG. 9.

For example, suppose that the user 1 requests the agent to reproduce music after the user 1 requests the agent to reproduce a video and while the agent 2 is suspending the processing. In this case, a plurality of voice output content is reproduced simultaneously, the voice is mixed, so the agent 2 asks the user 1 which request to execute.

If the agent 2 receives not the conflicting processing request (No in Step 804), but a request for the subsequent processing of the suspending processing, the agent 2 takes a measure for the request for the subsequent processing (Yes in Step 805).

The measure for the request of the subsequent processing is a measure on the assumption that the agent 2 receives the request which is before and after the suspending request while the request of the user 1 is suspending.

For example, suppose that if the user 1 requests the agent 2 to send a message and the user 1 requests the agent 2 to send a message to the same person while the agent 2 is suspending the processing. Since there is a possibility that the user 1 sends a later message on the assumption that the other person sees the message transmitted first, the agent 2 suspends the processing of the both requests and then performs the processing in the order in which they were requested when moving to the flowchart of FIG. 9.

In this case, the timeout times of FIG. 7 and FIG. 8 are set to be shorter timeout times set for both requests.

If there is no case in which the agent 2 makes it difficult to authenticate the user 1 (No in Step 805), the agent 2 continues to authenticate the user 1.

In the present embodiment, the processing of Steps 801 and 802 shown in FIG. 15 corresponds to determining the possibility that the execution of the modal authentication is interrupted. In addition, Yes in each step corresponds to the case where the execution of the modal authentication may be interrupted. Furthermore, “measure against going out” and “measures against sleeping” correspond to the processing for preventing the interruption of the execution of the modal authentication.

In addition, Yes in Steps 803 to 805 shown in FIG. 15 corresponds to a case where another request of the user related to the request of the user suspending the execution of the processing is received. Furthermore, “measure against suspending “registration”, “measure against conflicting processing request”, and “measure against subsequent processing request” correspond to the processing in response to the relationship between the request of the user and the other request of the user suspending the execution of the processing.

By executing such a process, when the agent 2 cannot continue authentication while the processing from the user is suspending, it is possible to prevent the suspending processing from being abandoned, and thus it is possible to exhibit high usability.

Note that the order and the content of the flowchart of FIG. 15 are not limited to this. Any measures may be taken to deal with situations in which the authentication by the tracking by the user 1 may be difficult. Any measures may be taken for the request suspended by the user 1 and the newly requested request.

In the above, the agent 2, the camera 3, the microphone 4, the speaker 5, and the television 6 are illustrated in FIG. 1. It is not limited thereto and, for example, the agent 2 may be provided with any one of the configurations capable of displaying images such as the camera 3, the microphone 4, the speaker 5, and the television 6. Alternatively, the agent 2 may be configured in any one of the camera 3, the microphone 4, the speaker 5, and the television 6.

Furthermore, in the above, the agent and the modal authentication apparatus are separately configured, and the tracking to the user (modal authentication) and the user authentication are separately executed. It is not limited thereto and the agent and the modal authentication apparatus may be integrally configured and implemented as the information processing apparatus according to the present technology.

In the above description, the information processing method according to the present technology is executed by a computer such as the agent. However, the information processing method and the program according to the present technology may be executed by a user-operable computer and another computer capable of communicating via a network or the like. In addition, the information processing system according to the present technology may be constructed in conjunction with a user-operable computer and another computer.

That is, the information processing method and the program according to the present technology can be executed not only in a computer system composed of a single computer but also in a computer system in which a plurality of computers operate in conjunction with each other. Note that, in the present disclosure, a system means a collection of a plurality of components (apparatuses, modules (parts), and the like), and it doesn't matter whether or not all the components are in the same housing. Therefore, the system may include a plurality of apparatuses housed in separate housings and connected via a network and a single apparatus in which a plurality of modules is housed in one housing.

The execution of the information processing method and the program according to the present technology by the computer system include both cases in which, for example, the acquisition of the reliability of the modal authentication, setting of the reliability threshold, and suspending of the execution of the processing are executed by a single computer, and in which each processing is executed by different computers. The execution of each processing by the predetermined computer includes causing another computer to execute a part or all of the processing, and obtaining the result.

That is, the information processing method and the program according to the present technology can be applied to a configuration of cloud computing in which one function is shared and processed together among multiple apparatuses through a network.

It is also possible to combine at least two of the above-described features according to the present technology. That is, the various characteristic portions described in the respective embodiments may be arbitrarily combined without distinguishing from each other in the respective embodiments. It should be noted that the effects described above are merely illustrative and are not limitative, and may have an additive effect.

The present technology may also have the following structures.

(1) An information processing apparatus, including:
an acquisition section that acquires reliability of modal authentication executed on a user;
a setting section that sets a reliability threshold on the basis of a request of the user; and
a processing execution section that suspends execution of processing in response to the request of the user until the reliability of the acquired modal authentication becomes larger than the set reliability threshold.
   (2) The information processing apparatus according to (1), in which
the setting section sets the reliability threshold on the basis of a type of the request of the user.
   (3) The information processing apparatus according to (1) or (2), in which
the processing execution section executes processing based on an authentication result of the modal authentication if the reliability of the acquired modal authentication becomes larger than the set reliability threshold.
   (4) The information processing apparatus according to (3), in which
the processing execution section executes processing in response to the request of the user if the authentication result of the modal authentication is valid.
   (5) The information processing apparatus according to (3) or (4), in which
the processing execution section rejects the request of the user if the authentication result of the modal authentication is invalid.
   (6) The information processing apparatus according to any one of (3) to (5), in which
the processing execution section selects a warning mode if the authentication result of the modal authentication is invalid.
   (7) The information processing apparatus according to (6), in which
the warning mode is a mode in which the execution of the modal authentication on the user is restricted.
   (8) The information processing apparatus according to (6) or (7), in which
the warning mode is a mode in which the execution of the modal authentication on the user is prohibited.
   (9) The information processing apparatus according to any one of (1) to (8), in which
the setting section sets a timeout time on the basis of the request of the user, and
the processing execution section determines whether or not to continue suspending of the execution of the processing in response to the request of the user on the basis of the timeout time.
   (10) The information processing apparatus according to (9), in which
the setting section sets the timeout time on the basis of the type of the request of the user.
   (11) The information processing apparatus according to (9) or (10), in which
the processing execution section restricts the execution of the modal authentication on the user if the timeout time elapses before the reliability of the modal authentication becomes larger than the reliability threshold.
   (12) The information processing apparatus according to any one of (9) to (11), in which
the processing execution section determines a possibility that the reliability of the modal authentication becomes larger than the reliability threshold before the timeout time elapses.
   (13) The information processing apparatus according to (12), in which
the processing execution section restricts the execution of the modal authentication on the user if there is no possibility that the reliability of the modal authentication is larger than the reliability threshold before the timeout time elapses.
   (14) The information processing apparatus according to (12), in which
if the reliability of the modal authentication is not likely to become larger than the reliability threshold before the timeout time elapses, the processing execution section executes intermediate processing for increasing the reliability of the modal authentication.
   (15) The information processing apparatus according to (14), in which
the processing execution section executes, as the intermediate processing, processing including requesting the user to take an action for increasing the reliability of the modal authentication.
   (16) The information processing apparatus according to (14) or (15), in which
the processing execution section selects the intermediate processing on the basis of a burden on the user when performing an action required for the user to increase reliability of the modal authentication.
   (17) The information processing apparatus according to any one of (1) to (16), in which
the processing execution section determines a possibility that the execution of the modal authentication is interrupted, and executes processing for preventing interruption of the execution of the modal authentication if the execution of the modal authentication is interrupted.
   (18) The information processing apparatus according to any one of (1) to (17), in which
the processing execution section executes processing in accordance with a relationship between the request of the user suspending the execution of processing and another request of the user if receiving the other request of the user related to the request of the user suspending the execution of processing.
   (19) An information processing method executed by a computer system, including:
acquiring reliability of modal authentication executed on a user;
setting a reliability threshold on the basis of a request of the user; and
suspending execution of the processing in response to the request of the user until the reliability of the acquired modal authentication becomes larger than the set reliability threshold.
   (20) A program executable by a computer system, the program causing the computer system to execute steps of:
obtaining reliability of modal authentication executed on a user;
setting a reliability threshold on the basis of a request of the user; and
suspending execution of processing in response to the request of the user until the reliability of the acquired modal authentication is greater than the set reliability threshold.

### REFERENCE SIGNS LIST

1 user
7 agent
10 storage section
11 modal authentication apparatus
11 biological information acquisition section
12 modal authentication execution section
13 certification result information registration section
20 acquisition section
30 setting section
31 reliability threshold setting section
32 timeout time setting section
40 processing execution section
41 execution judgment section
42 warning mode section
43 intermediate processing section
50 request receiving section
60 notification control section
100 information processing apparatus

1. An information processing apparatus, comprising:
an acquisition section that acquires reliability of modal authentication executed on a user;
a setting section that sets a reliability threshold on a basis of a request of the user; and
a processing execution section that suspends execution of processing in response to the request of the user until the reliability of the acquired modal authentication becomes larger than the set reliability threshold.

2. The information processing apparatus according to claim 1, wherein
the setting section sets the reliability threshold on a basis of a type of the request of the user.

3. The information processing apparatus according to claim 1, wherein
the processing execution section executes processing based on an authentication result of the modal authentication if the reliability of the acquired modal authentication becomes larger than the set reliability threshold.

4. The information processing apparatus according to claim 3, wherein
the processing execution section executes processing in response to the request of the user if the authentication result of the modal authentication is valid.

5. The information processing apparatus according to claim 3, wherein
the processing execution section rejects the request of the user if the authentication result of the modal authentication is invalid.

6. The information processing apparatus according to claim 3, wherein
the processing execution section selects a warning mode if the authentication result of the modal authentication is invalid.

7. The information processing apparatus according to claim 6, wherein
the warning mode is a mode in which the execution of the modal authentication on the user is restricted.

8. The information processing apparatus according to claim 6, wherein
the warning mode is a mode in which the execution of the modal authentication on the user is prohibited.

9. The information processing apparatus according to claim 1, wherein
the setting section sets a timeout time on a basis of the request of the user, and
the processing execution section determines whether or not to continue suspending of the execution of the processing in response to the request of the user on a basis of the timeout time.

10. The information processing apparatus according to claim 9, wherein
the setting section sets the timeout time on a basis of the type of the request of the user.

11. The information processing apparatus according to claim 9, wherein
the processing execution section restricts the execution of the modal authentication on the user if the timeout time elapses before the reliability of the modal authentication becomes larger than the reliability threshold.

12. The information processing apparatus according to claim 9, wherein
the processing execution section determines a possibility that the reliability of the modal authentication becomes larger than the reliability threshold before the timeout time elapses.

13. The information processing apparatus according to claim 12, wherein
the processing execution section restricts the execution of the modal authentication on the user if there is no possibility that the reliability of the modal authentication is larger than the reliability threshold before the timeout time elapses.

14. The information processing apparatus according to claim 12, wherein
if the reliability of the modal authentication is not likely to become larger than the reliability threshold before the timeout time elapses, the processing execution section executes intermediate processing for increasing the reliability of the modal authentication.

15. The information processing apparatus according to claim 14, wherein
the processing execution section executes, as the intermediate processing, processing including requesting the user to take an action for increasing the reliability of the modal authentication.

16. The information processing apparatus according to claim 14, wherein
the processing execution section selects the intermediate processing on a basis of a burden on the user when performing an action required for the user to increase reliability of the modal authentication.

17. The information processing apparatus according to claim 1, wherein
the processing execution section determines a possibility that the execution of the modal authentication is interrupted, and executes processing for preventing interruption of the execution of the modal authentication if the execution of the modal authentication is interrupted.

18. The information processing apparatus according to claim 1, wherein
the processing execution section executes processing in accordance with a relationship between the request of the user suspending the execution of processing and another request of the user if receiving the other request of the user related to the request of the user suspending the execution of processing.

19. An information processing method executed by a computer system, comprising:
acquiring reliability of modal authentication executed on a user;
setting a reliability threshold on a basis of a request of the user; and
suspending execution of the processing in response to the request of the user until the reliability of the acquired modal authentication becomes larger than the set reliability threshold.

20. A program executable by a computer system, the program causing the computer system to execute steps of:
obtaining reliability of modal authentication executed on a user;
setting a reliability threshold on a basis of a request of the user; and
suspending execution of processing in response to the request of the user until the reliability of the acquired modal authentication is greater than the set reliability threshold.
